(19) United States
(12) Patent Application Publication
(10) Pub. No.: US 2009/0070217 A1
(43) Pub. Date: Mar. 12, 2009

(54) Targeted Advertisement Transmission and Delivery in a Bandwidth Limited Multicast Wireless System

(76) Inventors: Srinivasa Dharmaji, Cupertino, CA (US); Xin Feng, Basking Ridge, NJ (US)

Correspondence Address: GLENN PATENT GROUP, 3475 EDISON WAY, SUITE L, MENLO PARK, CA, 94025, US

(21) Appl. No.: 12/191,070

(22) Filed: Aug. 13, 2008

Related U.S. Application Data
(60) Provisional application No. 60/960,030, filed on Sep. 12, 2007.

(51) Int. Cl. G06Q 30/00

(52) U.S. Cl. 705/14

(57) ABSTRACT

A system and method thereof for the delivery of focused alternate content and advertisements to mobile devices that selectively targets groups in a bandwidth limited multicast wireless video transmission. The limited wireless bandwidth does not allow multiple focused alternate content to be transmitted during allowed spot time to effectively cover all the target groups. Thus, the invention enables the pre-delivery and selective buffering of alternate content files on a mobile device for each target group. Accordingly, one embodiment of the invention enables viewing of targeted advertisements and alternate content by the target groups by attaching metadata to the targeted advertisements that contain instructions for filtering and insertion into a video stream.

### CROSS REFERENCE TO RELATED APPLICATIONS

This patent application claims the benefit of U.S. provisional patent application Ser. No. 60/960,030, Targeted Advertisement Transmission and Delivery in a Bandwidth Limited Multicast Wireless System, filed Sep. 25, 2007, the entirety of which is hereby incorporated by this reference thereto.

### BACKGROUND OF THE INVENTION

1. Technical Field

The invention relates generally to the field of advertisements for mobile devices. More specifically, the invention relates to the field of alternate content and targeted advertisements over low bandwidth wireless multicast transmission to mobile devices.

2. Description of the Related Art

Mobile devices, e.g. cellular phones, personal digital assistants (PDAs), iPhones™, iPods™, and video game devices are increasingly popular in our mobile society. These devices, however, have limited bandwidth and storage memory capacity due to their size constraints. Because these devices provide services that require the use of high bandwidths, however, such as video and voice services, a tension exists between providing enough services for users and maintaining a conveniently portable device.

Mobile devices can display alternate content and advertisements. Alternate content is an additional medium for displayed content, for example, on a webpage. Alternate content allows a wider variety of clients to view the content. For example, if a picture on a webpage is written in JavaScript, many clients are unable to view it due to limitations in their equipment or Internet connectivity.

The alternate content can contain a text description of the content to allow users to understand the substance of the picture, despite these limitations. Alternate content is essential for mobile devices because of their limited capacity to display images on a websites and because of their limited connectivity due to wireless constraints. Some users, for example, may receive RSS feeds as plain-text only to enable faster delivery.

Advertisements can be targeted to individuals or a group of individuals according to user preferences. Individuals with similar characteristics can form target groups. These characteristics can include, e.g. location, age, viewing preferences, and other fixed and random criteria, as may be established continuously or from time-to-time. By generating advertisements that incorporate these group characteristics, advertisers can maximize the impact of advertising campaigns.

Unlike video displays that are physically connected to the network, where the data streams are supplied through high bandwidth cable or satellite, the wireless connectivity to the mobile device has limited bandwidth and the transmission is multi-cast to all the mobile devices simultaneously. Thus, the current technology cannot prove alternate content and advertisements to all target groups within the viewing population simultaneously during any single advertisement spot available for advertisement transmission (ad-spot).

FIG. 1 shows a prior art video transmission network architecture. The broadcast operator 120 provides a data stream of video content that contains advertisements 105. A broadcast account manager can distribute the video content using a broadcast service system that includes, e.g. an interaction server and a filecast server.

The mobile operator 110 controls the wireless transmission of data to the mobile devices 170. The mobile operator 110 can insert additional advertisements 110 into the video content.

The wireless transmission is multicast, which means that the information contained within the data stream is simultaneously transmitted to all mobile devices 170 that subscribe to that mobile operator 110. The multicast transmission limits the use of focused ad delivery to target groups of the mobile operator's customers.

Videos containing ads are not simply delivered to the mobile device for display. To be effective, the advertisement spots must be managed, addressed, and delivered to each target group with proper insertion of advertisement files in predefined ad-spots with stored advertisement clippings. Furthermore, data relating to the advertisements that are delivered to the mobile device must also be managed.

It would be advantageous to provide focused alternate content and advertisement delivery to targeted groups of mobile customers.

It would be further advantageous to provide a means for selectively transferring alternate content and advertisement files (ad files) to each mobile device for storage.

It would be further advantageous to develop a means for the targeted individual to view these ad files on the mobile device.

### SUMMARY OF THE INVENTION

In one embodiment, the invention is an ad-serving system for displaying advertisements on a mobile device to multiple target groups. The focused advertisement delivery is possible within the constraints of the low bandwidth of the wireless multicast transmission of content.

The ad-serving system uses offline or online delivery of focused advertisement files during low transmission periods of the connected networks for local download and storage. The ad-serving system thereby reduces the load on the public broadcast networks during peak viewing times.

The ad-serving system makes wider use of the broadband spectrum by delivering advertisements while the mobile device is offline using IP multicasting or unicast with limited bandwidth. The advertisements are stored locally on the mobile device and inserted into the content stream for viewing at a later time.

The use of filtered download for local pre-storage of the ad files specific to a target group reduces the need for large storage capacity on the mobile terminal by enabling selective storage of ad files.

The ad flow system enables the insertion of the stored focused advertisements at the appropriate ad spot based on instructions contained in a pre-stored ASG. This helps in achieving the targeted delivery of the focused advertisements without use of additional bandwidth at viewing time.

### BRIEF DESCRIPTION OF THE DRAWINGS

FIG. 1 is a block diagram that illustrates a prior art mobile broadcast network architecture according to one embodiment of the invention;

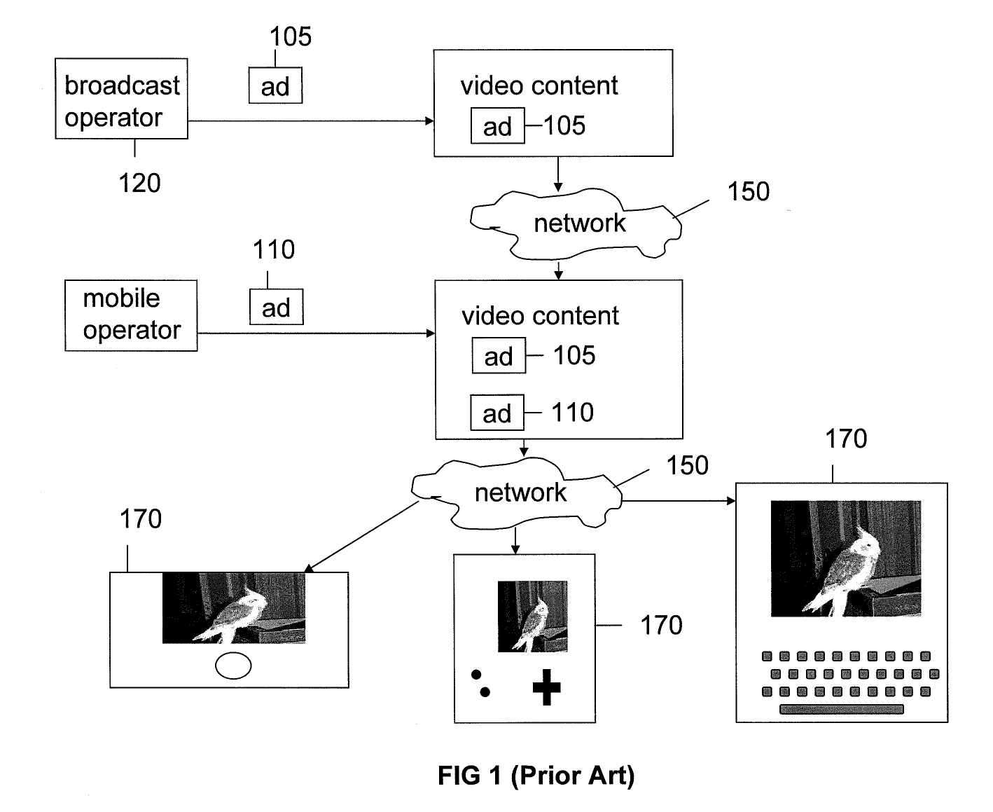

FIG. 2 is a block diagram that illustrates one embodiment of the proposed mobile broadcast network architecture;

FIG. 3 is a block diagram that illustrates the ad-serving system according to one embodiment of the invention;

FIG. 4 is a flow diagram that illustrates advertisement generation, spot assignment, policy decision making, scheduling and transfer of the advertisement on the ad-serving platform according to one embodiment of the invention; and

FIG. 5 is a flow diagram that illustrates inserting the ad file into the data stream on the mobile device according to one embodiment of the invention.

### DETAILED DESCRIPTION OF THE INVENTION

In one embodiment, the invention comprises a method and/or an apparatus for the delivery of focused alternate content and advertisement to mobile devices that selectively target groups in a bandwidth-limited multicast wireless video transmission. The limited wireless bandwidth prevents transmission of multiple focused alternate content during allowed spot time to effectively cover all the target groups. The invention enables the pre-delivery and selective buffering of alternate content files on a mobile device for each target group. Accordingly, in one embodiment, the invention is an ad-serving system for viewing of alternate content and ad files by target groups. The ad-serving platform generates an addressable spot-guide for specifying the target criteria of the advertisement and the ad spot where the ad file should be inserted.

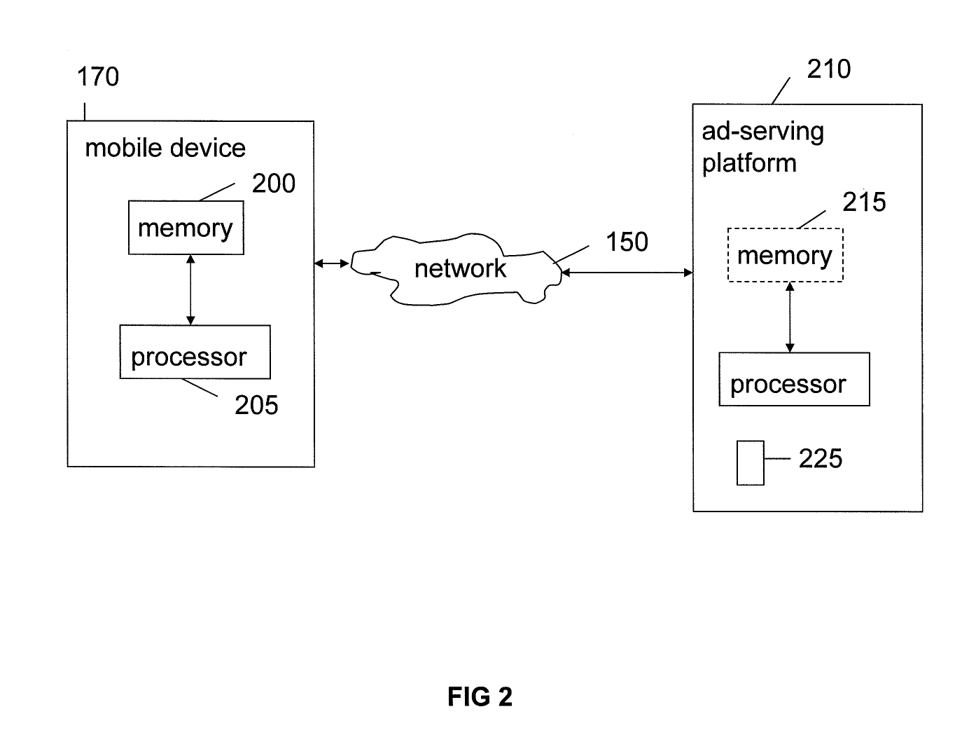

FIG. 2 is a simplified block diagram illustrating an exemplary architecture in which the ad-serving platform 210 is implemented. The exemplary architecture includes a mobile device 170, an ad-serving platform 210, and a network 150 connecting the mobile device 170 to the ad-serving platform 210.

A typical mobile device 170 may comprise a mobile video handset (handset), a personal digital assistant (PDA), or other mobile video display device. The client mobile device 170 is configured to include a computer-readable medium 200, such as random access memory or magnetic or optical media, coupled to an electronic processor 205. The processor 205 executes program instructions stored in the computer-readable medium 200.

The mobile device 170 is typically connected to the video broadcast network 150, e.g. 3G and receives video files in real-time, during non-use time, or while the device is offline. Alternate content or advertisement files can be delivered for storage in the device's local memory 200 during times when the video files are not received to minimize strains on the network 150. The alternate content and ad files can be selectively downloaded and stored and subsequently inserted into the video stream at an appropriate ad-spot. This pre-delivery of alternate content and local storage for timely insertion in an ad-spot facilitates the delivery of device specific alternate content without requiring extra bandwidth.

The ad-serving platform 210 includes a processor 205 coupled to a computer-readable medium 215. In one embodiment, the ad-serving platform 210 is coupled to one or more additional external or internal devices or servers, such as, without limitation, a secondary data storage element, such as a database 225 for storing the ad-files, alternate content, and addressable spot guide.

One or more user applications are stored in memories 200, in memory 215, or a single user application is partially stored in one memory 200 and partially stored in another memory 215.

The mobile device 170 filters and selectively downloads alternate content and ad files based on metadata called an addressable spot guide (ASG). The ASG also provides instructions for placement of the ad files and alternate content into the ad-spot during the video transmission. The generation and use of the ASG is disclosed in the co-pending application Addressable Spot Guide for Alternate Content Insertion, Application No. 60/960,329, filed Sep. 25, 2007 and assigned to a common assignee, the contents of which are herein incorporated in their entirety by this reference.

This targeted transmission, storage, and insertion works as part of the ad-serving system. Within the system, the mobile device users are categorized into target groups based on user preferences that fall within a targeted group. The focused advertisements are generated for each target group. These are downloaded and stored locally in the mobile devices of specific target groups along with corresponding alternate content. Based on the ASG, the stored advertisements and alternate content are inserted appropriately in the ad spots within the content stream for optimizing advertisement exposure.

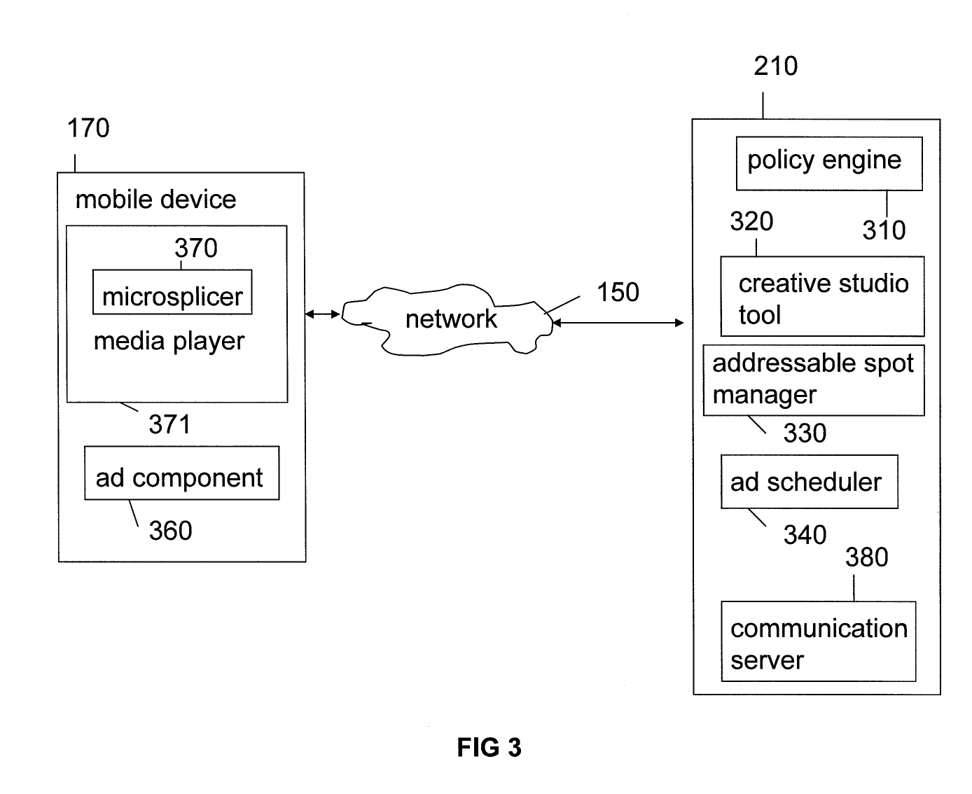

The ad flow system is illustrated in FIG. 3. The ad-serving platform 210 is a stationary sub-system connected to the network 150. The ad-serving platform 210 operates as an intermediary between the broadcast operator 120 and the mobile operator 110. It contains components for creating ASG, scheduling, and downloading advertisements as well as generating and transmitting focused advertisements and alternate content to the mobile device 170 using the components described below.

The ad-serving platform 210 contains a policy engine 310, a creative studio tool 320, an addressable spot manager 330, an advertisement scheduler 340, and a communication server 380. The scheduler 340 manages distribution of advertisements to the mobile device 170 while balancing spectrum availability, network capacity, handset storage capacity, and channel priority. The policy engine 310 defines the target groups taking into account the advertisement development and distribution considerations of the advertising campaign. The addressable spot manager 330 determines the appropriate ad spot for inserting advertisements into the content flow or viewing program.

The ad-serving platform 210 acts as an advertisement delivery system (ADS) that interacts with a mobile operator 110 and a video broadcast operator 120, and collects the details and characteristics of the ad spot where advertisement files are displayed. The ad-serving platform 210 develops and delivers advertisement files specific to each target group through mobile broadcast or Internet protocol (IP) multicast or through the cellular network to the mobile device 170. The pre-delivered advertisement files are delivered to each of the targeted groups, advertisement files are prioritized, and stored locally in the mobile terminal 170 for future insertion at specified ad spots based on the ASG. This method facilitates personalized advertisement rendering in ad spot without additional bandwidth. The components within the ad-serving platform 210 are discussed below.

The policy engine 310 generates and refines target group information and target profiles based on the customer preference information and demographic information provided.

The creative studio tool 320 generates interactive focused mobile ads based on the target group information and target group profiles generated by the policy engine 310 and ad campaign aims.

The addressable spot manager 330 optimizes addressable ad spots that can be handled based on network bandwidth capability, mobile terminal storage availability, and broadcast channels. Based on the above criteria, it defines the number of ad spots that can be used effectively for ad insertion and delivers customer specific ad files to be inserted at each ad-spot.

The scheduler 340 uses the information from the policy engine 310 and advertisement campaign rules to manage the optimum distribution of generated ads. The scheduler 340 uses the distribution criteria of focused advertisements to target groups using server based probabilistic algorithms that balance the spectrum utilization, ad campaign focus, device availability, and channel line-up. Both broadcast and mobile IP multicast/unicast methods are used in delivering ad files to mobile devices 170. An ASG containing metadata information can be delivered along with the ad files to the mobile device 170 for filtering ad files and proper insertion in ad spot for viewing.

A communication server 380 manages the interaction between the mobile device 170 and the scheduler 340 and handles the transfer of the ad files and ASG to the mobile device 170. It typically also provides the processing power for all applications residing on the ad-serving platform 210.

The mobile device 170 contains an ad component 360 that is embedded or downloadable with necessary display plug-ins and is stored in memory 200. The ad component 360 interacts with the scheduler 340 on the ad-serving platform 210 to manage a profile, filter ads before download, and enable storing of only the focused ads for the target audience, scheduling of programs, and policy execution. The ad component 360 downloads the ad files, alternate content, and ASG through a server client and stores the files, alternate content, and ASG in local memory 200. The ad component 360 uses the information in the ASG as the reference for filtering ad files specific to the mobile device 170. The ad component 360 also manages housekeeping and cleaning of unwanted files to maximize the available memory.

The mobile device 170 contains a media player 371, which includes a media player plug-in called microsplicer 270 for detecting meta-data in the video streams. The microsplicer 370 can insert the advertisements into the correct time slots during the video data playback. The micro-splicer 370 receives information from the ad component 360 for proper insertion of the ad files in the ad spot. Microsplicer 370 detects the start of ad spot from the ASG and inserts ad files as applicable. Micro-splicer 370 also stops the advertisement at the end and switches back to the content stream.

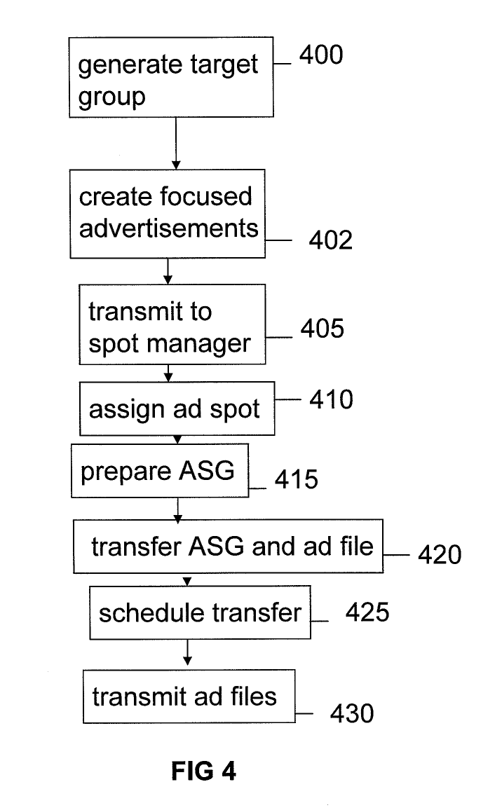

FIG. 4 is an illustration of a flow diagram for generating an ad file and ASG for targeted advertisement transmission within the ad-serving platform 210.

The policy engine 310 generates 400 a target group for receiving advertisements based on a defined criteria. The creative studio tool 320 creates 402 the focused advertisements for each target group using the pre-defined characteristics of the target group and the identified aims of the ad campaign. The advertisements are transmitted 405 to the spot manager 320. The spot manager 320 assigns 410 the ad spot in the content stream. The ad file inventory has spot details for each advertisement along with the video advertisement within the ad file. This database is passed to the policy engine 330 to prepare 415 an ASG based on the metadata on the ad file, campaign policy, and target group for each advertisement in an ad file.

The ad file and ASGs are transferred 420 to the scheduler 340. The scheduler 340 schedules 425 transfer of the ad files to the mobile devices 170. The communication server 380 transmits 430 the ad file and ASG to the targeted clients, typically by video broadcast or mobile IP download using a broadcast channel in multicast or unicast delivery based on coverage. This can be done effectively during idle times or low use periods of the connected network to reduce the load on the network at peak times

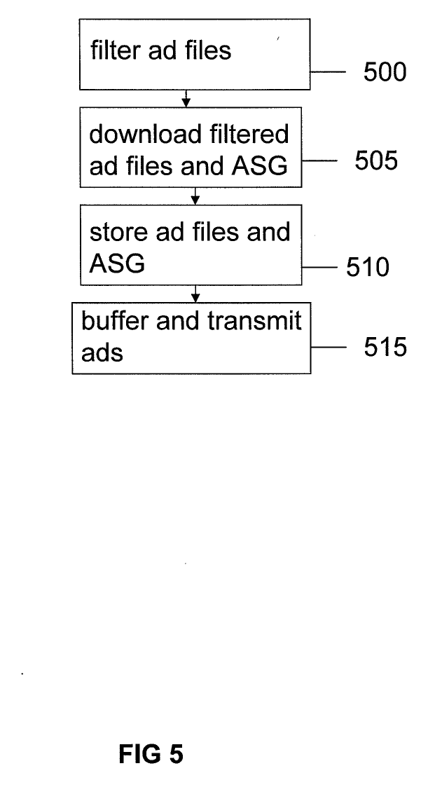

FIG. 5 is a flow diagram that illustrates the steps of viewing targeted ads on a mobile device 170. The mobile device 170 downloads 500 the ad files, alternate content, and ASG with a server that is part of the ad component 360. The server filters 500 the ad files and downloads 505 the ad files, alternate content, and ASG according to instructions in the ASG. The ad files, alternate content, and ASG are stored 510 in a database 225. The database 225 buffers 515 and transmits the advertisements and alternate content to the microsplicer 370 for advertisement insertion into the content stream. The micro-splicer 370 inserts the chosen advertisement and alternate content as applicable and transfers the content to media player 371. The ad component 360 also handles all memory management functions including aging, clean up, and house keeping activities.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer system for generating at least one targeted advertisement and inserting said targeted advertisement into a video stream displayed on a mobile device, the computer system comprising:
an ad-serving platform for generating a targeted advertisement and an addressable spot guide (ASG), the ad-serving platform comprising:
a policy engine for generating a target group and said ASG using a plurality of characteristics of mobile device users;
a creative studio tool for generating said targeted advertisement based on said plurality of characteristics for said target group and a plurality of rules for an advertisement campaign;
an addressable spot manager for defining at least one advertisement spot for insertion of said targeted advertisement;
an advertisement scheduler for scheduling a transmission of said targeted advertisement to said mobile device; and
a communication server for transmitting said targeted advertisement and ASG to said mobile device;
an advertisement component stored on said mobile device for filtering and downloading said targeted advertisement using said ASG; and
a media player incorporated into said mobile device, said media player comprising a microsplicer for inserting said targeted advertisement into a video stream using said ASG.

2. The computer system of claim 1, wherein the ad-serving platform generates alternate content for insertion into a video stream displayed on said mobile device.

3. The computer system of claim 1, wherein said communication server transmits said targeted advertisement and said ASG to said mobile device while said mobile device is offline.

4. The computer system of claim 1, wherein said targeted advertisement and said ASG are downloaded before said mobile device receives said video content.

5. The computer system of claim 1, wherein said ad-serving platform further comprises a database for storing said targeted advertisement and said ASG.

6. The computer system of claim 1, wherein said microsplicer instructs said media player to switch from said video stream to said targeted advertisement and back to said video stream when said targeted advertisement ends.

7. A method of delivering at least one targeted advertisement to a mobile device, the method comprising the steps of:
generating a target group for receiving at least one advertisement based on a plurality of characteristics of a group of mobile device users;
generating said advertisement for said target group using said plurality of characteristics;
assigning an advertisement spot in said video stream for inserting said targeted advertisement;
generating a addressable spot guide (ASG) for each targeted advertisement that contains instructions for associating said advertisement with said target group and instructions for inserting said targeted advertisement into said video stream at said advertisement spot;
transmitting said targeted advertisement and said ASG to said mobile device; and
inserting said targeted advertisement into said video stream using said ASG.

8. The method of claim 1, further comprising the step of filtering said targeted advertisements and selecting said targeted advertisement for download using said ASG.

9. The method of claim 1, further comprising:
generating an alternate content;
transmitting said alternate content to said mobile device; and
inserting said alternate content into said video stream using said ASG.

10. The method of claim 1, further comprising storing said targeted advertisement and said ASG on said mobile device.

11. The method of claim 1, further comprising scheduling the transfer of said targeted advertisement and said ASG during a time when said mobile device is idle.

12. An ad-serving platform for generating at least one targeted advertisement and at least one addressable spot guide (ASG) comprising:
a policy engine for generating a target group and said ASG using a plurality of characteristics of a group of mobile device users;
a creative studio tool for generating said targeted advertisement based on said pre-defined characteristics of said target group and a plurality of rules for an advertisement campaign;
an addressable spot manager for defining at least one advertisement spot for insertion of said targeted advertisement;
an advertisement scheduler for scheduling a transmission of said targeted advertisement to said mobile device; and
a communication server for transmitting said targeted advertisement and ASG to said mobile device.

13. The ad-serving platform of claim 12, wherein said advertisement scheduler schedules said transmission of said targeted advertisement and said ASG to said mobile device for a time when said mobile device is idle.

14. The ad-serving platform of claim 12, wherein said target advertisement and said ASG are transmitted using multicast transmission.

15. The ad-serving platform of claim 12, wherein said plurality of characteristics of said mobile device users include at least one of sex, age, gender, location, and demographics.

16. The ad-serving platform of claim 12, wherein said creative studio tool alternate content for insertion into a video stream displayed on said mobile device.

17. The ad-serving platform of claim 12, wherein said ad-serving platform further comprises a database for storing said targeted advertisement and said ASG.
